(19) United States
(12) Patent Application Publication
(10) Pub. No.: US 2009/0183428 A1
(43) Pub. Date: Jul. 23, 2009

(54) DEVICE FOR FASTENING AND HOLDING A CREEPING PLANT ALONG A CARRYING WIRE

(75) Inventor: Miquel Massaguer Agullo, Terrassa (ES)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/295,905

(22) PCT Filed: May 18, 2007
(86) PCT No.: PCT/EP07/04450

§ 371 Date: Oct. 3, 2008

(30) Foreign Application Priority Data
Jun. 15, 2006 (FR) 06/05348

(51) Int. Cl. A01G 17/04

(52) U.S. Cl. 47/44

(57) ABSTRACT

A device for securing and holding a plant creeping along a support wire (11), comprising a fastener (12) configured as a skewed-surface, open ring composed of an annular web (21), which delimits an internal volume (13) for receiving the plant through an access opening (16), and a pair of hooks (14, 15), which are bent back outwardly at the ends of said web to form semi-open retaining eyes (17) that are offset in the heightwise direction and make it possible to exert a wedging effect on the support wire due to oblique deformation relative to the vertical direction. The fastener (12) is hingeless and is made in one piece from biodegradable material.

### CROSS-REFERENCE TO RELATED APPLICATION

This application is a U.S. National Phase Patent Application based on International Application Serial No. PCT/EP2007/004450 filed May 18, 2007, the disclosure of which is hereby explicitly incorporated by reference herein.

### BACKGROUND OF THE INVENTION

1. Field of the Invention.

The present invention concerns a device for securing and holding a plant creeping along a support wire, comprising a fastener equipped with means for receiving the plant and elements for hooking the support wire.

2. Description of the Related Art.

In the field of agriculture, numerous varieties of creeping plants have to be attached to a vertical support wire as they grow. The field of application of the invention is, in particular, the raising of tomatoes, cucumbers, beans, etc., where there is vertical growth that must be kept under control. This type of farming is done on a large scale in greenhouses, using a network of vertical support wires attached to horizontal support wires placed at a set level. The plants are sowed near the vertical support wires, and as the plant grows, it must be secured to a support wire by means of fasteners. Without the presence of these fasteners, the plant cannot grow. The plant grows approximately in parallel along the vertical support wire, which is not fixed at ground level, but hangs from the horizontal support wire.

In the cultivation of vegetables, it is known to make use of flexible ties to attach the plants to a support. Most of these ties are in the form of self-tightening hoops. These hoops must be mounted precisely, so as to keep a certain amount of play to allow for increases in the diameter of the plants during growth. The ties are generally made of biodegradable plastic or plasticized metal.

The document CH 269995 describes a fastener in the form of a pincer used to hold a plant on a vertical stake planted in the ground. The stake must be rigid so that the end of the pincer can take hold. Such a fastener is not suitable for a non-rigid, small-sized support wire.

The document CH 364498 relates to a fastener for supporting a plant, said fastener being configured as a metal pin composed of two movable elastic branches whose bent-back ends carry hooks that are able to hook onto each other. The branches are articulated about a hinge constituting a torsion spring, which is threaded longitudinally onto a rigid stake. The hooks on the metal pin may injure the user, however, and damage the plant as they are being put in place.

The document WO 02/084161 cites a torsion clip formed by a tab that is folded in the center by means of a hinge to form an upside-down V. Each branch is provided with a substantially circular opening to receive the plant that is to be supported, and an adjacent eye into which a support wire can be introduced. Such a clip is nevertheless able to slip along the support wire, and may drop down in the case of non-rigid vertical support wire.

Other known clips form hinged collars that have a positive clipping effect. Attachment to the support wire is effected by pinching the wire at the level of the hinge. Installation is complicated, since the support wire has to be carefully positioned at that hinge level. Moreover, ageing tests have demonstrated mechanical strength problems due to breakage of the hinge or the clipping system.

### SUMMARY OF THE INVENTION

The present invention provides a fastener for a plant creeping along a support wire, which has good mechanical strength combined with rapid installation, and which is environmentally friendly when disposed of by composting.

The securing and holding device according to the invention is characterized in that the fastener is configured as a skewed-surface, open ring including a circular web delimiting an internal volume for receiving the plant through an access opening and a pair of hooks bent back outwardly at the ends of the web to form semi-open retaining eyes that are offset in the heightwise direction and make it possible to exert a wedging effect on the support wire due to oblique deformation relative to the vertical direction.

The wedging effect is due to the friction of the support wire on the insides of the eyes of the two mutually offset hooks. Installation of the fastener around the creeping plant is quick and easy and requires no moving parts, hinges or deformation of material.

According to one embodiment, the fastener has a first branch provided with one of the hooks in a same plane, and a second branch extending via a helix portion to the other hook, which is situated at another level. The eye of each hook is subdivided into two regions of different section for retaining a support wire of a set diameter, the posterior region, farthest inside the eye, being provided for a fine wire. The two support-wire retaining regions are separated from each other by a constriction constituting a friction point for immobilizing the support wire inside the posterior region.

The fastener and the support wire may be made of biodegradable material, thus permitting fast disposal of the plant (minus its fruit), fastener and support wire together. The farmer thus gains valuable time, without having to remove all the fasteners and support wires. The whole assemblage can go straight to composting once the fruits or vegetables have been harvested.

In one form thereof, the present invention provides a device for securing and holding a creeping plant along a support wire, comprising a fastener equipped with means for receiving the plant and elements for hooking the support wire, characterized in that the fastener is configured as a skewed-surface, open ring composed of an annular web delimiting an internal volume for receiving the plant through an access opening, and a pair of hooks, which are bent back outwardly at the ends of the web to form semi-open retaining eyes that are offset in the heightwise direction and make it possible to exert a wedging effect on the support wire due to oblique deformation relative to the vertical direction.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic perspective view of the fastener according to the invention, the support wire not being shown;

FIG. 2 is a plan view of FIG. 1;

FIGS. 3 and 4 are front and profile views of the fastener of FIG. 1; and

FIG. 5 shows the fastener of FIG. 1 mounted on a support wire after the plant has first been placed inside the web.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

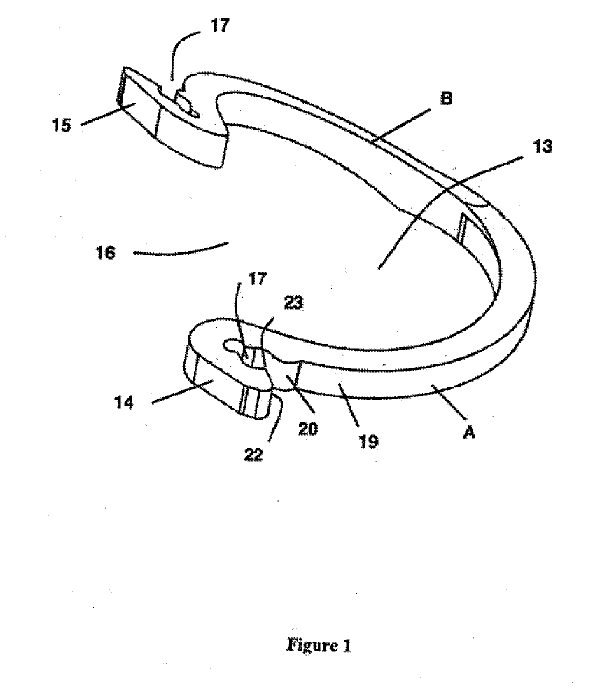

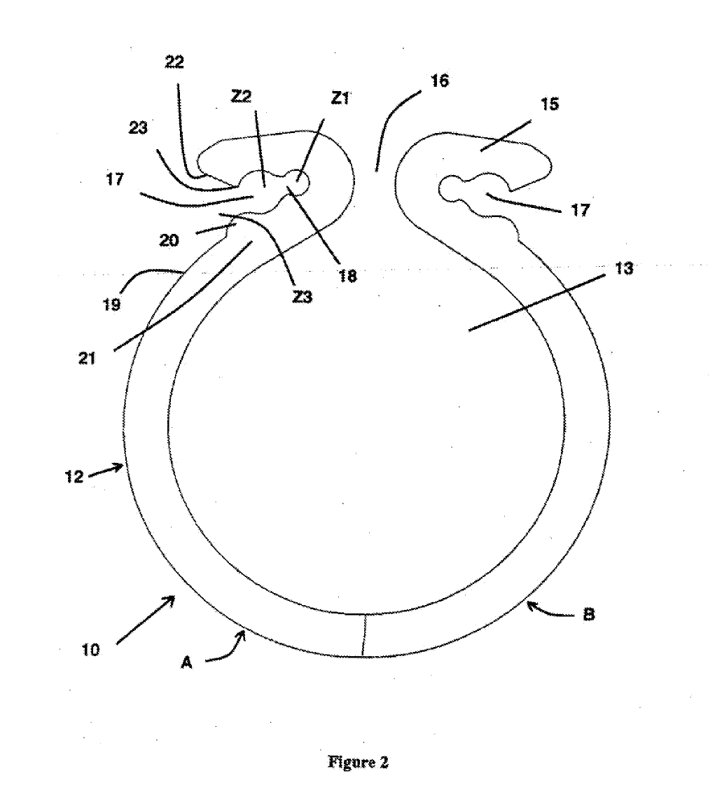

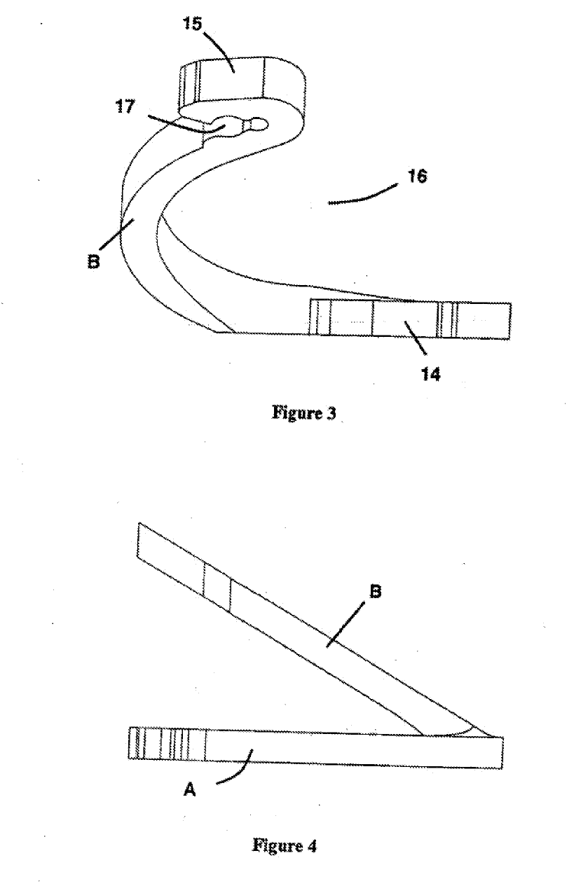

Referring to FIGS. 1 to 5, a device 10 for securing and holding a creeping plant on a vertical support wire 11 comprises a hingeless clip or fastener 12 configured in one piece as a three-dimensional open ring. The internal volume 13 of the ring represents the space available for receiving the body of the creeping plant, while the support wire 11 is made fast by being wedged in two hooks 14, 15 provided in the ends of the clip 12.

The clip 12 is advantageously made of biodegradable material, which eliminates the need to remove the securing clips from the support wires after the fruit has been picked. The support wires can also be made of biodegradable material, for example of paper, such that they can be recycled by composting at the same time as the plant, stripped of its fruit and the clips 12.

The ring of the clip 12 is composed of a first branch A equipped with a hook 14, and a second branch B provided with another hook 15. First branch A is arranged in a semi-circle extending in the same plane XY, while second branch B originates in the middle region of the ring and proceeds in a vertical direction identified as Z, in the process forming a helix portion. The sections of the two branches A and B are substantially identical, and the three-dimensional offset in the Z direction creates an access opening 16 to the internal volume 13 of the ring.

The hook 14 of first branch A is bent back outwardly, forming a semi-open eye 17 into which the support wire 11 is introduced. The inside of the eye 17 is subdivided into two regions Z1, Z2 of different section, separated from each other by a constriction 18. The posterior region Z1 is located farthest inside the eye 17, and serves to hold the support wire 11 on the clip 12. The constriction 18 operates both as a friction point during the introduction of the support wire 11 and as a mechanism for immobilizing the wire in posterior retaining region Z1.

Intermediate region Z2, which is larger, is designed to receive a support wire 11 of larger diameter than that provided for posterior region Z1.

The entrance to eye 17 includes an insertion region Z3 having a sliding surface 19 and a boss 20, which are spaced out along the web 21 and are external to the internal volume 13 of hook 14. The boss 20 is disposed opposite a beveled edge 22 in which the hook terminates and a stop projection 23, which prevents support wire 11 from escaping from retaining region Z2.

Hook 15 of second branch B is identical in structure to hook 14. The two hooks 14, 15 are offset at different levels and are separated from each other by access opening 16.

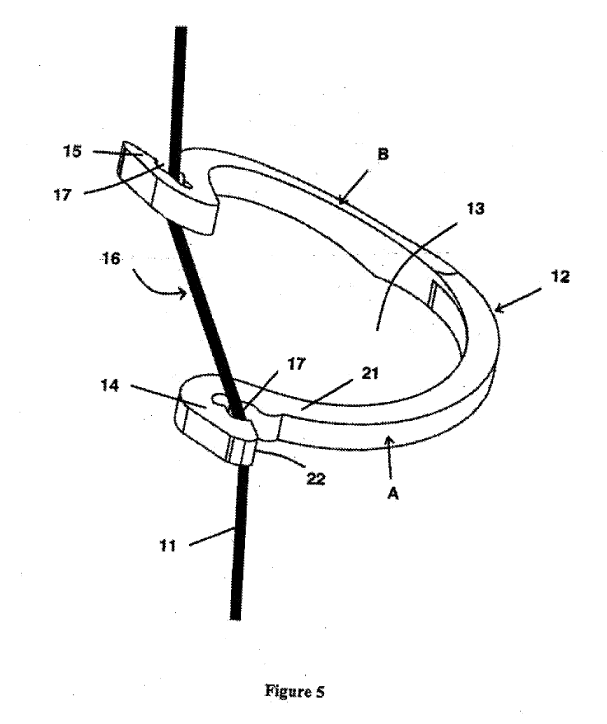

The mounting of a clip 12 according to the invention around the body of the plant is performed in the following manner, with reference to FIG. 5.

The opening 16 of the clip 12 is held opposite the plant to be supported, and the body of the plant is introduced into the available internal volume 13 of the ring. The clip 12 is then rotated a quarter-turn with one hand to introduce the support wire 11 into the eye 17 of the hook 14 of first branch A. The other hand is used to catch support wire 11 in the other hook 15, that of second branch B. The support wire 11 is inclined with respect to the vertical as it passes through opening 16. This deformation in the clip 12 causes a frictional effect inside the hooks 14, 15, thereby reinforcing the mechanical strength and the hold of the clip 12 on the support wire 11.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-6. (canceled)

7. A device for securing and holding a creeping plant along a support wire, comprising:
a fastener configured as a skewed-surface, open ring and comprising:
an annular web delimiting an internal volume for receiving the plant through an access opening; and
a pair of hooks bent back outwardly at respective ends of said web to form semi-open retaining eyes, said retaining eyes offset in a vertical direction to exert a wedging effect on the support wire due to oblique deformation relative to said vertical direction.

8. The device of claim 7, wherein said fastener comprises a first branch provided with one of said hooks in a same plane as said first branch, and a second branch extending from said first branch via a helix portion to the other said hook, said other said hook located at a level vertically spaced from said one hook.

9. The device of claim 7, characterized in that each of said eyes of said hooks is subdivided into two regions of different cross-section for retaining a support wire having a diameter, including a posterior region disposed farthest inside said eye and provided for a wire having a relatively lesser diameter.

10. The device of claim 9, wherein said two regions for retaining said support wire are separated from each other by a constriction constituting a friction point for immobilizing said support wire inside said posterior region.

11. The device of claim 9, wherein said intermediate region is larger in size than said posterior region, and is preceded, at an entrance to said eye, by a boss disposed opposite a beveled edge and a stop projection.

12. The device of claim 7, wherein said fastener is monobloc and is made of a biodegradable material.
